(19) United States
(12) Patent Application Publication
(10) Pub. No.: US 2007/0024519 A1
(43) Pub. Date: Feb. 1, 2007

(54) Rod antenna

(75) Inventor: Gunther Blickle, Walddorfhaslach (DE)

Correspondence Address: THE FIRM OF KARL F ROSS, 5676 RIVERDALE AVENUE, PO BOX 900, RIVERDALE (BRONX), NY, 10471-0900, US

(73) Assignee: HIRSCHMANN CAR COMMUNICATION GMBH

(21) Appl. No.: 11/496,055

(22) Filed: Jul. 28, 2006

(30) Foreign Application Priority Data
Aug. 1, 2005 (DE) 102005036114.5

(51) Int. Cl. H01Q 1/36

(52) U.S. Cl. 343/895; 343/715

(57) ABSTRACT

The invention relates to a rod antenna, in particular a mobile radio antenna for vehicles as well as method of making a rod antenna, the rod antenna having a connector (1) and receiving means, in particular a spiral shaped antenna coil that are enclosed by casing material (9), the connector (1) being made of a conductive material, having connection means at one end, for example a thread, a bayonet or the like for attachment to an antenna base that is connected to the vehicle when it is ready for use and/or on one mold part (7) during the molding and having at the other end a seat for the receiving means, wherein according to the invention the seat of the connector (1) is designed as a sleeve (2) in which the antenna coil is fixed.

The invention relates to a rod antenna, in particular a mobile radio antenna for vehicles, where the rod antenna has a connector and receiving means, in particular a spiral-shaped antenna coil, that are enclosed by casing material, the connector being made of a conductive material and having connection means at one end, for example a thread, a bayonet or the like, for connection to an antenna base that is connected to the vehicle when it is ready for being used and/or to a mold during the molding process and having a seat at the other end for the receiving means, according to the features of the preamble of the patent claim 1.

A rod antenna of this type and a method of making a respective antenna is known from the EP 1 318 565 A1. The connector of the rod antenna has a throughgoing bore, such that during the molding process, a guide pin can be inserted that is attached to the mold and is provided as a support for the antenna coil during the injection process of the casing material. The connector furthermore has a bolt having an external thread that is formed as an integral part of the casing, such that the guide pin as well as the connector must be screwed separately into the mold and be removed again therefrom, which causes increased work. Furthermore, the antenna coil is inserted in a shoulder of the bore of the connector. This fact as well is not advantageous, since the attachment between these two components can only be effected by soldering due to the massive design of the connector.

The object of the invention is therefore to avoid these disadvantages and to provide a rod antenna as well a method of the manufacture thereof in which the reception of the antenna is improved and the molding cost is reduced.

The object is attained by the features of patent claim 1.

According to the invention the seat of the connector is formed as a sleeve in which the antenna coil is fixed. By designing the seat of the connector as a sleeve, the antenna coil can be guided optimally, and any connection of the antenna coil can be provided. The connection of the antenna coil can for example be effected by inserting and stamping, by inserting and soldering or even by screwing the antenna coil into the sleeve. Therein, it is not absolutely necessary that an internal thread for the antenna coil is provided in the sleeve. It is sufficient if the dimensions of the sleeve and of the antenna coil are adapted to each other such that the external perimeter of the antenna coil is screwed into the sleeve under pressure.

In an advantageous manner, the antenna coil is designed as a spiral spring made of spring steel, the conductivity for electrical high-frequency functioning being improved by copper plating the surface of the spiral spring. The sleeve of the connection area in an advantageous manner is designed as having a length that is sufficient for achieving a high-frequency radio function of the rod antenna due to this area in addition to the sole connection function of the antenna coil. An AM/FM function is achieved by the part of the spiral spring that projects freely from the sleeve. Ideally, no coil for decoupling the frequency areas is necessary. In case this is not possible, a suitable coil is provided for the transmission of a high-frequency phone function that is placed on the antenna coil or the spiral spring such that it is in contact with the connector and is connected, preferably soldered, with the sleeve and spiral spring in this position. The coil can also be designed preferably with generally the same diameter as the antenna coil and be inserted between the connector and the antenna coil. In particular when an antenna coil is used that is a spiral spring, the spring can have areas with different pitches for optimizing the electrical function of the antenna coil and/or for minimizing material expense.

The connector advantageously is made of brass and nickel-plated to achieve good contact with the antenna coil and possibly to the coil as well as to the antenna base. For minimizing molding cost for the connector, a molding of the connector and/or the sleeve by means of a molding method, in particular extrusion, stamping or rolling is proposed.

A good attachment of the connector in the casing material, in particular for safely locking the connector, is achieved if a noncircular sectional shape and/or axial and/or radial and/or tangential grooves are provided in some areas and/or along the entire outer length, which assure a good connection between the connector and the casing material after hardening.

The connector advantageously has a central passage that itself is known. An internal thread can be provided in this passage, in the area that does not face the sleeve, by means of which the connector can be screwed into a threaded pin of the antenna base. A threaded pin can also be screwed into the internal thread of the connecting part and can be screwed to the antenna base. The connector however can also have a recess along the central passage, in particular in the area that does not face the sleeve, in which a threaded pin is screwed that then serves as a screw for connection to the antenna base.

The proposed internal thread in the connector can receive a pin during the molding process of the external thread, that projects through the passage of the connector and at least one part of a passage in the antenna coil, the projecting part of the external thread of the pin being screwed into the mold.

The pin can advantageously be slightly tapered at its free end, for easy removal after extruding with casing material. As casing material, a material is proposed that remains elastic after cooling and that is made of thermoplastic material, e.g. Santoprene.

The central passage in the connector has a sealing area after the recess or the internal thread in direction to the sleeve that is designed, like the section of the pin, such that during molding, no casing material can permeate through the sealing area.

Due to the proposed features, a very simple structure of the rod antenna is possible, since it can also be fabricated without a pin when the strength of the spiral spring is sufficiently high. Furthermore, an easy molding of the rod antenna is possible, since it can be fabricated without additional means, even without soldering. An optimized design is thus possible, no holes for holding means or seams being necessary in the casing material. By means of only one model, an AM/FM and a radio function are possible. For the rod antenna, only a basic variant for the antenna base with internal thread sleeve or external threaded bolt is required. Any desired flexural strength as well as good return behavior can be achieved.

As a method of making a rod antenna according to one of the preceding features, it is proposed that the antenna coil be attached to the sleeve of the connector, that the connector be fixed to the mold, that the mold part be connected to a one-part or multiple-part mold whose internal shape corresponds to the outer contour of the rod antenna, that the casing material be injected into the mold, and that the rod antenna be extracted. In addition, a pin can be inserted into the central passage of the connector and into the antenna coil or a part of the antenna coil and be connected to the connector, in this case, the remaining threaded area of the pin can be used for securing the pin and the connector to the mold.

Furthermore, a pressure pin can be provided axially in line with the pin and that is fixed to the pin before the injection of the casing material, and the pressure pin is pulled back in the compression phase of the molding operation for closing the passage of the pressure pin. Fixing of the pressure pin on the pin is possible due to the fact that the pressure pin fits in a recess of the pin situated on the front face of same.

As further measure, it is proposed that after removing the pin, at least one rod-shaped insert is fitted into the passage of the antenna coil and is fixed in a desired position. This way, a directed modification of the flexural strength of the rod antenna can be achieved, where a rod made of hard rubber, GRP and similar material is proposed as insert. It is also possible that the insert rod not extend along the entire length of the cavity of the rod antenna. Fixing of the insert rod can be achieved by a press connection, due to an oversizing of the insert rod, by gluing, by wedging, and the like. In this manner, it is possible to combine areas of high flex strength of the rod antenna with areas of low flex strength or respectively good flexibility in a controlled manner. Also several short insert rods can be provided.

For further description of the invention that it is however not limited to, reference is made to the drawings in which embodiments of the invention are illustrated in a simplified manner. In the drawings,

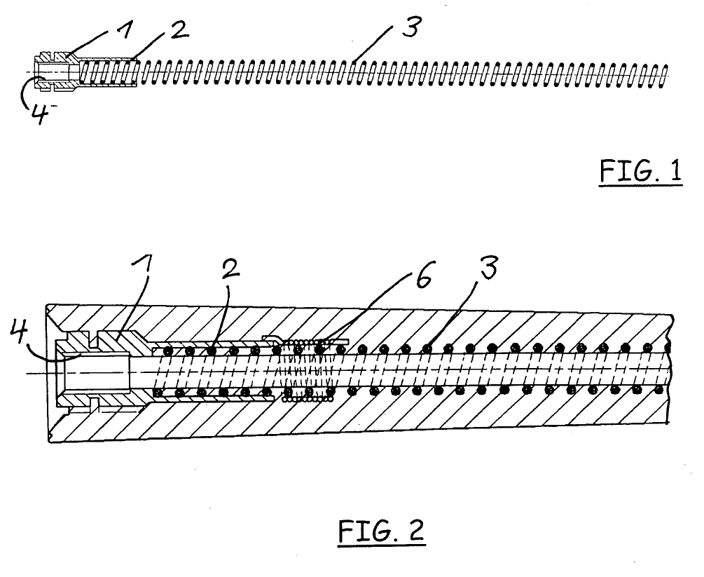

FIG. 1 is a longitudinal section of a connector and an antenna coil designed as a spiral spring,

FIG. 2 is a partial section of a rod antenna having a connector, a spiral spring, coil and casing material,

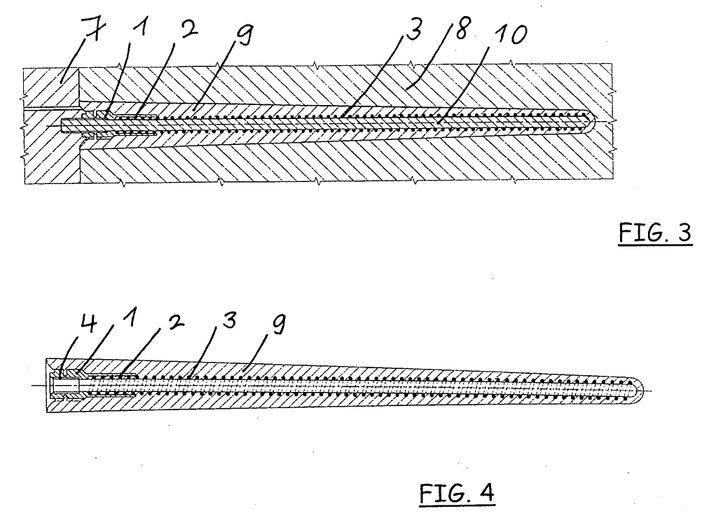

FIG. 3 is a longitudinal section of a rod antenna as well as the section of first and second mold parts,

FIG. 4 is a longitudinal section of a finished rod antenna and internal thread in the connector,

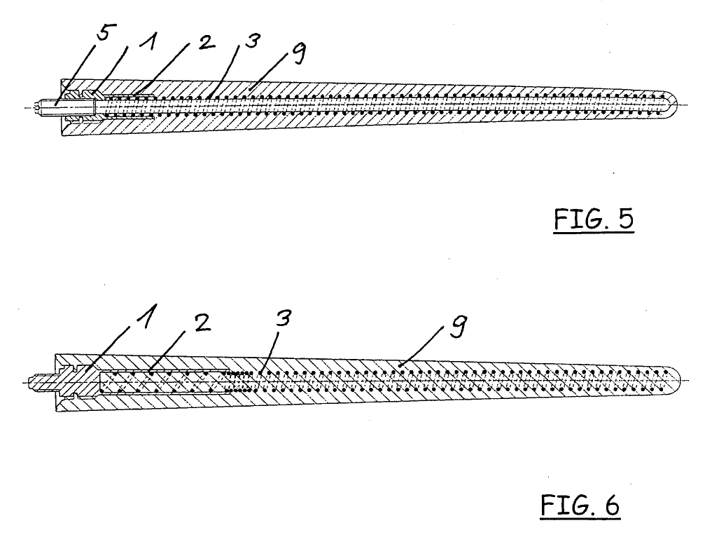

FIG. 5 is a longitudinal section of a rod antenna according to FIG. 4 with a threaded pin inserted into the connector,

FIG. 6 is a longitudinal section of a modified rod antenna having a threaded pin that is formed as an integral part of the connector,

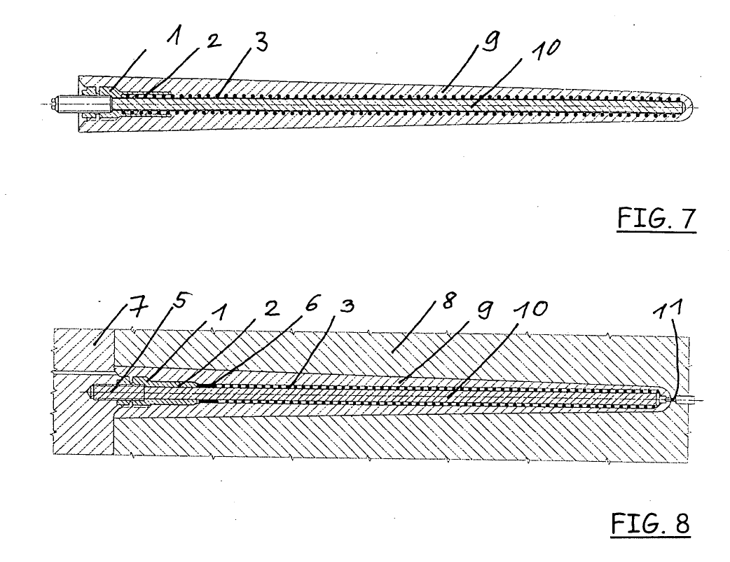

FIG. 7 is a longitudinal of a rod antenna with an inserted pin, and

FIG. 8 is a longitudinal section of a rod antenna having a first mold part, a second mold part and a pressure pin.

In FIGS. 1 and 8, a connector is referenced 1, as far as it is represented individually, on which a sleeve referenced 2 is formed as an integral part. A spiral spring referenced 3 is inserted into the sleeve 2 an is slightly pressed into the sleeve. The connector 1 typically has an internal thread 4 on its rear end facing away from the sleeve by means of which the antenna rod can be connected to an unillustrated antenna base connected to the vehicle. The antenna base has threaded parts that correspond to the connector 1 and that can be designed as a nut as well as as a screw. The internal thread 4 of the connector 1 can receive a threaded pin 5, as represented in FIG. 5, that then projects from the connector 1 and that can be screwed into an antenna base. On the connector 1, a pin can be formed as an integral part, as represented in FIG. 6, that has an external thread.

The AM/FM function is typically achieved due to the spiral spring 3 that projects from the sleeve 2. The sleeve 2 itself can also assume the high-frequency telephone function of the rod antenna in addition to its fixing function. In case this should not suffice, a coil referenced 6 that has the same diameter as the spiral spring 3 is mounted behind the sleeve or around the spiral spring, as shown in FIGS. 2 and 8 and is electrically connected to the sleeve.

The connector 1, the spiral spring 3 and possibly the coil 6 are attached to a first mold part 7 as a finished component (FIGS. 3 and 8). Around the connector 1 and the spiral 3, a second mold part 8 is mounted and connected to the first mold part 7. The cavity that is formed by the connector 1, the spiral spring 3 and possibly the coil 6 and the internal shape of the second mold part 8 and the first mold part 7 is filled by injection with a casing material 9. Preferably, it a thermoplastic material that is still elastic but stiff after cooling.

In case the spiral spring 3 does not have sufficient stability before injection of the casing material, a pin referenced 10 is inserted through the central passage in the connector 1 and into the cavity of the spiral spring 3 and connected to the first mold part 7, preferably screwed, such that the pin 10 considerably improves the stability of the spiral spring 3. The pin 10 has a threaded end that can be screwed into the internal thread 4 of the connector 1 and into the first mold part 7.

As represented in FIG. 6, the spiral spring 3 can have areas having different pitches for optimizing the electrical function of the rod antenna.

In the embodiment according to FIG. 8, the connector 1 is first screwed on the pin, and then, in case telephone function is intended, the coil 6 is inserted and after that, the spiral spring 3 is applied and the coil 6 as well as the spiral spring 3 are soldered to the connector 1. In the case of a soft spiral spring 3, a shrink tube can be pulled over the spiral spring 3, the coil 6 and the sleeve 2 of the connector 1 and can be shrunk by heating and thus be stressed to provide a higher stability to the components. The pin 10 according to FIG. 8 has at its free end a bore that can be brought into an effective connection with the pressure pin 11 such that the end of the pin 10 is further stabilized during the injection of the casing material. When the casing material is still under pressure, directly after injection, the pressure pin 11 is moved away from the pin 10 such that the opening in the casing material is closed.

List of Reference Numbers

1 connector

2 sleeve

3 spiral spring

4 internal thread

5 threaded pin

6 coil

7 first mold part

8 second mold part

9 casing material

10 pin

11 pressure pin

1. A rod antenna, in particular a mobile radio antenna for vehicles, the rod antenna having a connector (1) and receiving means, in particular a spiral antenna coil, that are enclosed by casing material (9), the connector (1) being made of conductive material and having connection means at one end, e.g. a thread, a bayonet or the like, for attachment to an antenna base that is connected to the vehicle when it is ready for use and/or to a first mold part (7) during the molding and having a seat at its other end for the receiving means, characterized in that the seat of the connector (1) is designed as a sleeve (2) in which the antenna coil is fixed.

2. The rod antenna according to claim 1, characterized in that the antenna coil can be fixed in the sleeve (2) by inserting and stamping, by inserting and soldering or by screwing.

3. The rod antenna according to one of claims 1 or 2, characterized in that the antenna coil is designed as a spiral spring (3) made of spring steel.

4. The rod antenna according to claim 3, characterized in that the surface of the spiral spring (3) is copper plated.

5. The rod antenna according to one of the preceding claims, characterized in that the length and the radial dimensions of the sleeve (2) are designed such that a high-frequency phone function of the rod antenna can be achieved by means of this area of the connector (1).

6. The rod antenna according to one of the preceding claims, characterized in that for transmission of the high-frequency phone function, a coil (6) is provided that is preferably provided in the area between the sleeve (2) and the antenna coil.

7. The rod antenna according to claim 6, characterized in that the coil (6) is connected to the sleeve (2) and the antenna coil, preferably soldered with the same.

8. The rod antenna according to one of the preceding claims, characterized in that the antenna coil is designed with different pitches along its length, preferably in its design as a spiral spring (3).

9. The rod antenna according to one of the preceding claims, characterized in that the connector (1) is made of brass and nickel-plated.

10. The rod antenna according to one of the preceding claims, characterized in that the connector (1) and/or the sleeve (2) is fabricated by means of a molding method, in particular extrusion, stamping or rolling.

11. The rod antenna according to one of the preceding claims, characterized in that the connector (1) has a noncircular cross-sectional shape and/or axial grooves and/or tangential grooves in some areas and/or along its entire outer length.

12. The rod antenna according to one of the preceding claims, characterized in that the connector (1) has a central passage that is provided with an internal thread (4) at least in the area that does not face the sleeve (2).

13. The rod antenna according to one of the preceding claims, characterized in that at least during the molding process, a pin (10) is provided that projects through the passage of the connector (1) and at least one part of a passage of the antenna coil, in that the pin (10) has an external thread area that projects from the connector (1) and is screwed at least with the first mold part (7).

14. The rod antenna according to claim 13, characterized in that an external thread of the pin (10) is screwed into an internal thread (4) of the connector (1).

15. The rod antenna according to one of claims 13 or 14, characterized in that after removal of the pin (10), a threaded pin (5) is screwed into the internal thread (4) of the connector (1) that can further be screwed into an internal thread of the antenna base with its extension.

16. The rod antenna according to one of the preceding claims, characterized in that a central passage of the connector (1) has a recess into which a threaded pin (5) is pressed, in particular in the area that does not face the sleeve (2).

17. The rod antenna according to one of the preceding claims characterized in that the pin (10) is designed slightly tapered on its free end.

18. The rod antenna according to one of the preceding claims characterized in that the passage in the connector (1) is sealed by a sealing area against the cross-section of the pin (10) such that during the molding, no casing material (9) can permeate into the recess or the internal thread (4).

19. A method of making a rod antenna according to one of the preceding claims, characterized in that the antenna coil is attached to the sleeve (2) of the connector (1), that the connector (1) is attached to the first mold part (7), that the first mold part (7) is connected to a one-piece or multiple-piece mold (8) that corresponds with its internal shape to the outer contours of the rod antenna, that the casing material (9) is injected into the die, and that the rod antenna is molded.

20. The method according to claim 19, characterized in that before the molding process, the pin (10) is introduced through passages in the connector (1) and the antenna coil and an external thread of the pin (10) is screwed to the first mold part (7).

21. The method according to one of claims 19 or 20, characterized in that before molding, the pin (10) is introduced through the passages in the connector (1) and the antenna coil, and the external thread area of the pin (10) is screwed into an internal thread (4) of the connector (1) and then an external thread area of the pin (10) is screwed into the first mold part (7).

22. The method according to one of the preceding claims, characterized in that on a second part of the mold (8) a pressure pin (11) is provided that is in axial alignment with the pin (10) and that is fixed by means of the pin (10) before injecting the casing material (9) and that the pressure pin (11) in the dwell pressure phase of the casing material (9) is pulled back to close the opening of the pressure pin (11).

23. The method according to one of the preceding claims, characterized in that after the removal of the pin (10), at least one rod-shaped insert is introduced into the passage of the connector (1) and/or the passage of the antenna coil and is fixed therein in a desired position.
